(19) United States
(12) Patent Application Publication
(10) Pub. No.: US 2023/0196009 A1
(43) Pub. Date: Jun. 22, 2023

(54) SYSTEMS AND METHODS FOR BROWSER RENDERING

(71) Applicant: CenturyLink Intellectual Property LLC, Broomfield, CO (US)

(72) Inventors: Dean Ballew, Sterling, VA (US); John R.B. Woodworth, Amissville, VA (US)

(73) Assignee: CenturyLink Intellectual Property LLC, Broomfield, CO (US)

(21) Appl. No.: 17/935,421

(22) Filed: Sep. 26, 2022

Related U.S. Application Data
(60) Provisional application No. 63/292,691, filed on Dec. 22, 2021.

(51) Int. Cl. G06F 40/197; G06F 40/143; G06F 16/957

(52) U.S. Cl. CPC G06F 40/197; G06F 16/9577; G06F 40/143

(57) ABSTRACT

Systems and methods for evaluating rendering of a webpage are provided. In an example, a render of a portion of a webpage is analyzed to determine if the webpage is being properly loaded at a device. Loading of a webpage may be based on a browser loading the webpage and/or device information (e.g., an operating system running on the device, if the device is a desktop or mobile device, the size of the device, etc.). Renders of the webpage are analyzed to determine if a browser and/or device information is certifiable or suspect for the webpage. Browsers and/or device information that is certified may allow exemption of analysis of renders sent from devices with the same browser and/or device information. Alternatively, devices that have browsers and/or device information that is suspect may be sent feedback providing recommendations for alternate browsers or redirected to a simpler interface for the webpage.

### CROSS-REFERENCE TO RELATED APPLICATIONS

This application claims the benefit of U.S. Provisional Application No. 63/292,691 filed Dec. 22, 2021, entitled “Systems and Methods for Browser Rendering,” which is incorporated herein by reference in its entirety.

### BACKGROUND

A device may use one of many web browsers to load a webpage of a website. A rendering engine, residing in the browser, is used to load elements of the webpage by rendering a script, a markup language document, and/or style sheet for the webpage. Different browsers and different versions of browsers, however, may use different rendering engines, which may cause the rendering process and sequence of loading of a webpage to be different from browser-to-browser (or between different versions of the same browser). These differences in rendering engines may cause different browsers to load a webpage differently, providing different experiences to users for the same webpage.

It is with respect to these and other general considerations that the aspects disclosed herein have been made. Also, although relatively specific problems may be discussed herein, it should be understood that the examples should not be limited to solving the specific problems identified in the background or elsewhere in this disclosure.

### SUMMARY

Examples of the present disclosure describe systems and methods for evaluating rendering of a webpage or website by one or more browsers.

Aspects of the present disclosure may include a computer-implemented method for evaluating rendering of a webpage, the computer-implemented method comprising receiving a request for a webpage, and, in response to the request, sending the webpage and instructions to obtain browser information and rendering information associated with the webpage. The method may further include receiving the browser information and the rendering information associated with the webpage. The method may continue by storing at least a portion of the browser information and the rendering information in a log, analyzing the rendering information, and certifying the browser information, based at least in part on the rendering information.

In another aspect, the present disclosure may include a computer-implemented method for evaluating rendering of a webpage, the computer-implemented method comprising receiving a request for a webpage, and, in response to the request, sending the webpage and instructions to obtain browser information and rendering information associated with the webpage. The method may continue by receiving the browser information and the rendering information associated with the webpage, and storing at least a portion of the browser information and the rendering information in a log. Further, the method may include analyzing the rendering information, and determining that the browser information is suspect, based at least in part on the rendering information.

In another aspect, the present disclosure may include a system for evaluating rendering of a webpage, the system comprising at least one processor, and memory storing instructions that when executed by the at least one processor cause the system to perform a set of operations. In examples, the set of operations may comprise receiving, from a browser, a request for a webpage, and, in response to the request, sending, to the browser, the webpage and instructions to obtain browser information and rendering information associated with the webpage to be loaded at the browser, wherein the browser information identifies a type of the browser. The set of operations may continue by receiving, from the browser, the browser information and the rendering information associated with the webpage, and storing at least a portion of the browser information and the rendering information in a log. In examples, the set of operations also includes comparing the rendering information with a template, and, based at least on comparing the rendering information with the template, certifying the browser information for the webpage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 depicts an example system for evaluating rendering of a webpage or website by one or more browsers.

FIGS. 2A-2C depict example webpage renderings on different graphical user interfaces.

FIG. 3 depicts an example operating environment.

FIG. 4 depicts an example method, from a web server perspective, for evaluating rendering of a webpage by one or more browsers.

FIG. 5 depicts another example method, from a browser perspective, for evaluating rendering of a webpage by one or more browsers.

### DETAILED DESCRIPTION

As described briefly above, a device may use one of many web browsers to load a webpage of a website. A rendering engine, residing in the browser, is used to load elements of the webpage by rendering a script, a markup language document, and/or style sheet for the webpage. Different browsers and different versions of browsers, however, may use different rendering engines, which may cause the rendering process and sequence of loading of a webpage to be different from browser-to-browser (or between different versions of the same browser). These differences in rendering engines may cause different browsers to load a webpage differently, providing different experiences to users for the same webpage.

For example, modern web browsers may use a variety of resources and technology from a variety of locations. This may result in a webpage or website being rendered visually via scripts (e.g., JavaScript), markup language documents (e.g., HTML), and/or style sheets (CSS). Due to nuances in vendor implementations, one or more portions of a webpage or website may fail to render. In some situations, the entire webpage or website may fail to render, resulting in a blank page. As described herein, rendering of the webpage or website may depend on browser information (e.g., a type of the browser, a version of the browser, or other information associated with the identification of the web browser) and/or device information (e.g., an operating system running on the device, a display size of the device, a device type, etc.).

When developing a webpage or website, developers or operators may not know how the webpage or website is rendering on one or more different browsers. This may result in developers or operators being blind to the actual user experience (UX) delivered to a user via a browser. Webpages or websites not rendering properly, if at all, may lead to user frustration, overburdening of the webpage or website (e.g., if users are stuck on a specific page, reloading the page, etc.), loss of commerce that would otherwise be associated with proper rendering of the page (e.g., rendering of advertisements, available purchases, etc.), or overburdening of the developer and/or operator of the webpage or website (e.g., concerned or frustrated customers inquiring about the webpage or website and/or services otherwise provided through the webpage or website).

Although developers or operators may run tests to determine how a webpage or website is rendering on different browsers, these tests are often time consuming and/or inaccurate. For example, standardized feature testing, such as the ACID test, may not be accurate for all browsers (in particular, mobile browsers). In another example, due to the large quantity of browsers available, a smaller development team and/or a release on a restricted timeline may be unable to test rendering of the webpage or website on all potential browsers prior to release.

Solutions to unknown renderings across different browser information and/or device information may include analyzing renders of a webpage or website loaded by different browsers. A rendering engine of a browser is often capable of determining when a render of a webpage or website has completed. Additionally, rendering engines of browsers often produce custom renders based on a device (e.g., printer, mobile device, etc.). In an example, a solution may include generating a render of the current webpage or website served from a web server to a browser and, once the load has completed at the browser, sending the render from the browser to the web server.

The render may be scaled down for performance (e.g., a screenshot of a portion of a webpage, a compressed image of a portion of a webpage, a text encoding representative of a screenshot of a portion of a webpage, etc.). Additionally, the render may be obfuscated, anonymized, and/or aggregated for security purposes (e.g., via lorem ipsum text replacements).

The renders received by the web server may be stored in a log. Additionally, the renders may be analyzed by the web server or a developer or operator to assess rendering of the webpage or website across multiple browsers and/or operating systems. For example, browsers and/or operating systems may be certified or indicated as suspect, based on the renders. Renders may be compared with a template. Further, renders may be analyzed by artificial intelligence (AI) and/or machine learning (ML) technologies. In an example where a render or renders indicates that a browser and/or operating system is not properly rendering a webpage or website, the web server may provide feedback to a browser to provide recommendations for alternate browsers or may redirect the browser to load a simpler interface for the website or webpage.

Accordingly, the present technology provides systems and methods for analyzing renders of webpages or websites across different browsers. Although discussion of the present technology may refer to rendering of a webpage, rendering of multiple webpages and/or a website or website(s) are also considered.

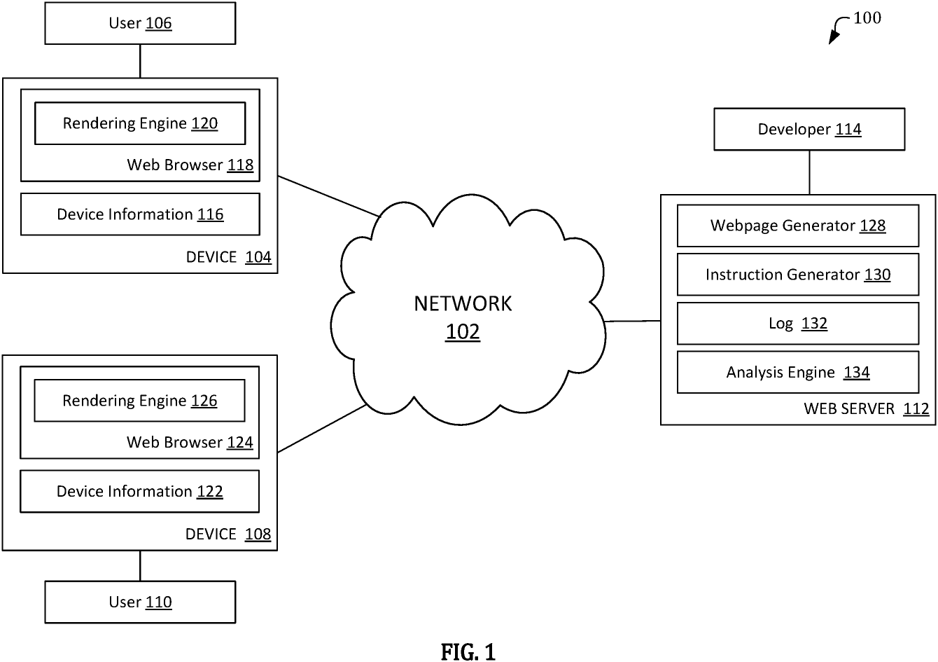

FIG. 1 depicts an example system 100 for evaluating rendering of a webpage or website by one or more browsers. As shown, the system 100 includes a network 102, a device 104 operated by a user 106, another device 108 operated by another user 110, and a web server 112 operated by a developer 114.

The network 102 may be a private network 102 or a public network 102 (e.g., the Internet). As shown, the network 102 enables communication between the devices 104, 108 and the web server 112. The network 102 may include other components or devices not shown in FIG. 1, such as other servers or devices, test points, routers, gateways, switches, ports, hubs, bridges, modems, repeaters, access points, etc. These network components (not shown) may be connected to each other and/or to other devices or servers connected to the network 102 (such as the devices 104, 108 and/or web server 112), via a wired or wireless connection. Components of the network 102 and devices and servers connected to the network 102 may communicate over the network 102 and may pass traffic between each other over the network 102.

The devices 104, 108 are capable of running web browsers 118, 124 to render a webpage or website served by a web server 112 over a network 102. In the example shown in FIG. 1, a device 104 includes a web browser 118 with a rendering engine 120 and device information 116. Similarly, another device 108 includes a web browser 124 running a rendering engine 126 and device information 122. The web browser 124, rendering engine 126, and device information 122 of the device 108 may be different from the web browser 118, rendering engine 120, and device information 116 of device 104. Additionally, the devices 104, 108 may also include other components not shown in FIG. 1, such as drives, processors, memory, power supplies, adapters, network interface cards, etc.

The device information 116 of a device 104 may include an operating system (OS) running on the device, a display size of the device, a device type (e.g., mobile device, desktop device, printer, etc.), or other information about the device 104. The device information 122 of another device 108 may be the same or different than the device information 122 of device 104. For example, a device 104 may run an Android® operating system and another device 108 may run Windows® 10 desktop operating system.

The web browsers 118, 124 of the devices 104, 108 may be any web browser capable of loading a webpage and executing instructions provided by a web server 112 associated with the webpage. The web browsers 118, 124 may include a type of web browser (e.g., Internet Explorer®, Edge®, Firefox®, Opera®, Safari®, Chrome®, etc.) and a version of a web browser (e.g., versions of Internet Explorer® include Internet Explorer® 6, Internet Explorer® 7, Internet Explorer® for Mac, etc.). The type of web browser may depend on device information 116, 122 of the device 104, 108 on which the web browser 118, 124 is running. For example, a mobile device may run Chrome® for Android® or Chrome® for iOS® and a desktop device may run Chrome® for desktop. As described above, the web browser 124 of another device 108 may be the same or different than the web browser 118 of device 104. For example, the web browser 118 of device 104 may be a different type and/or version than the web browser 124 of device 108.

The web browsers 118, 124 include rendering engines 120, 126 that reside on the web browser 118, 124. The rendering engines 120, 126 contain elements or logic to render a webpage (e.g., received from a web server 112). Different web browsers 118, 124 (e.g., different types and/or versions of web browsers) may be associated with different rendering engines 120, 126. Different rendering engines 120, 126 may include different rendering processes and/or sequences to render a webpage. Examples of rendering engines 120, 126 include Trident® (MSHTML), Blink®, EdgeI®, Gecko®, Presto®, Webkit®, WebCore®, KHTML, etc.

The web server 112 may communicate with the devices 104, 108 over the network 102. As shown in FIG. 1, the web server 112 may include a webpage generator 128, an instruction generator 130, a log 132, and an analysis engine 134. Additionally, the web server 112 may also include other components not shown in FIG. 1, such as drives, processors, memory, power supplies, adapters, network interface cards, etc.

The webpage generator 128 allows the web server 112 to communicate a webpage and/or a website to a device 104, 108. For example, the web server 112 may receive a request from a device 104, 108 to fetch a webpage or website. In response to the request, the webpage generator 128 of the web server 112 may retrieve webpage-generating information (or website-generating information) and send the webpage-generating information to the requesting device 104, 108. The webpage-generating information may include a style sheet, markup language documents, a script, and/or a header. The rendering engine 120, 126 of the web browser 118, 124 of the device 104, 108 receiving the webpage-generating information may then use the webpage-generating information to load the requested webpage.

The web server 112 may also include an instruction generator 130. The instruction generator 130 may provide instructions to be carried out by the rendering engine 120, 126 of the web browser 118, 124. The instructions may cause a web browser 118, 124 to obtain and send rendering information about a webpage. Rendering information may include a screenshot of at least a portion of the webpage, a compressed image of at least the portion of the webpage, a text encoding representative of the screenshot of at least the portion of the webpage, or any other information or file representative of one or more user interface elements loaded on a webpage. Additionally, the instructions may cause the web browser 118, 124 to send device information (e.g., as described above) associated with the sending device 104, 108 and/or browser information (e.g., a type of the browser, a version of the browser, or other information associated with the identification of the web browser 118, 124) associated with the web browser 118, 124 communicating with the web server 112. The instructions from the instruction generator 130 may be provided with the webpage-generating information from the webpage generator 128. For example, the instructions may be provided in a header of the webpage-generating information. Alternatively, instructions may be provided separately from the webpage-generating information, such as in a special call.

Additionally, the instructions provided by the instruction generator 130 may be specific for a web browser 118, 124 and/or device information 116, 122. For example, the instructions for a web browser 118 of a device 104 may be executed to instruct the web browser 118 to take a screenshot of, or obtain a representation of, at least a portion of a loaded webpage. The same instructions for a different web browser 124 for another device 108 may be executed to provide feedback to a user 110 of the device to load the webpage in a different browser. The same instructions for yet a different web browser (running on a same or different device) may be executed to not take further action (e.g., to not take a screenshot or not obtain a representation of the webpage or not provide feedback, etc.). Alternatively, instructions may be customized by the instruction generator 130 of the web server 112, based on the request for the webpage sent by a web browser 118, 124. For example, in the request for the webpage, the web browser 118, 124 may include browser information and/or device information. The instructions may then be customized based on the browser information and/or device information.

The web server 112 may also include a log 132. As described herein, instructions from the instruction generator 130 of the web server 112 may instruct a receiving web browser 118, 124 to obtain and/or send rendering information about webpage(s) or website(s), device information 116, 122 for the device 104, 108, and/or browser information about the web browser 118, 124. After a web browser 118, 124 executes instructions and sends rendering information to the web server 112, the web server 112 may store the rendering information in the log 132. The rendering information may be stored in the log 132 in association with device information and/or browser information received with the rendering information. For example, the log 132 may include the information shown in Table 1, below. Although Table 1 includes both browser information and device information, one or the other may not be included. Additionally, although Table 1 shows a browser type for browser information and an operating system for device information, other information may be stored for browser information and/or device information, as described herein.

TABLE 1

| | | | |
|---|---|---|---|
| Rendering Information | Proper Rendering? | Browser Information | Device Information |
| Image File 1 | Yes | Browser Type 1 | OS 1 |
| Image File 2 | No | Browser Type 2 | OS 2 |
| Image File 3 | Yes | Browser Type 1 | OS 1 |
| Image File 4 | Yes | Browser Type 3 | OS 3 |
| Image File 5 | No | Browser Type 1 | OS 4 |
| Image File 6 | Yes | Browser Type 2 | OS 3 |
| Image File 7 | Yes | Browser Type 1 | OS 1 |
| Image File 8 | No | Browser Type 2 | OS 2 |
| Image File 9 | Yes | Browser Type 1 | OS 4 |

As shown in FIG. 1, the web server 112 may also include an analysis engine 134. The analysis engine 134 is capable of analyzing rendering information (e.g., received at the web server 112 and/or stored in the log 132). Analysis of the rendering information may be for the purpose of determining if webpage(s) or website(s) have rendered properly. Proper rendering is loading of webpage elements in positions, sizes, and/or locations desired by a developer 114. In an example, proper rendering may be determined based on a comparison with a template for the webpage(s) or website(s). For instance, if rendering information is determined to be the same or substantially the same as a template (e.g., with the template being in a comparable format as the rendering information), then the webpage(s) or website(s) have proper rendering. Alternatively, if the rendering information is determined to be substantially different from the template, then rendering of the webpage(s) or website(s) may be improper or problematic. Comparison of rendering information with a template and/or other rendering information may be performed by artificial intelligence and/or machine learning techniques implemented by the analysis engine 134. Although an analysis engine 134 is described and shown to evaluate rendering information, evaluation of the rendering information may instead be performed by an engine external to the server, by a developer 114 or operator, or by any other entity or technique capable of comparing any format of rendering information (e.g., image file, text encoding, etc.).

If the analysis engine 134 determines that the rendering information suggests a rendering problem (e.g., improper rendering or problematic rendering), then the webpage generator 128 of the web server 112 may send a new webpage to the web browser 118, 124, such as a webpage with fewer style sheets, a webpage without a style sheet, or a low-tech webpage. Additionally or alternatively, the webpage generator 128 may send feedback to the web browser 118, 124 in real time indicating that a rendering issue of the webpage. The web browser 118, 124 may display the feedback for viewing by a user 106, 110 of the device 104, 108. Feedback may include a message indicating that the current web browser 118, 124 is not compatible with the webpage and/or a message indicating options for a compatible web browser.

Regardless of whether the webpage(s) or website(s) are determined to be properly or improperly rendered, the analysis engine 134 may evaluate other rendering information associated with the same browser information and/or device information to determine if a pattern exists among browser information and/or device information. For example, referring to Table 1, Browser Type 1 running on OS 1 may be certified for proper rendering of a webpage because Image File 1, Image File 3, and Image File 7 indicated proper rendering (e.g., a pattern of proper rendering was found for rendering information associated with Browser Type 1 and OS 1). In another example, still referring to Table 1, Browser Type 2 running on OS 2 may be flagged as suspect for improper rendering of a webpage because Image File 2 and Image File 8 indicated improper rendering (e.g., a pattern of improper rendering was found for rendering information associated with Browser Type 2 and OS 2). Alternatively, no pattern may be detected for Browser Type 2 only (e.g., without pairing of device information) based on proper rendering of Image File 2 and improper rendering of Image File 6. Likewise, no pattern may be detected for Browser Type 3 and/or Browser Type 3 running on OS 3 because Image File 4 is the only rendering information available for that browser information and/or browser information paired with device information (e.g., insufficient rendering information available to determine if Browser Type 3 and/or Browser Type 3 running on OS 3 renders a webpage properly). Similarly, no pattern may be detected for Browser Type 1 running on OS 4 (e.g., associated with Image File 5) and Browser Type 2 running on OS 3 (e.g., associated with Image File 6).

If a pattern for proper or improper rendering is detected, then a report may be sent or displayed for a developer 114 of the web server 112. Additionally or alternatively, if a pattern is detected, instructions may be updated with the instruction generator 130. For example, if browser information and/or device information is determined to be suspect (e.g., result in improper rendering of a webpage), then the instructions may be updated to automatically provide redirecting (e.g., to a low-tech webpage) and/or feedback (e.g., to display a message indicating that the web browser is incompatible) to an incompatible web browser requesting delivery of a webpage from the web server 112. In another example, regardless of whether the browser information and/or device information is determined to be suspect or certified, the instructions may be updated to not request rendering information about the webpage to be sent from the web browser 118, 124 (e.g., because a pattern has already been detected and additional rendering information may not be required or desired). This may lower computational burden on the web browser 118, 124 (and therefore the device 104, 108) collecting rendering information, browser information, and/or device information. Additionally, computational burden may be lowered for the web server 112 by reducing an amount of information received for storage in the log 132.

Additionally or alternatively, if a pattern is detected, the log 132 may be updated. For example, rendering information associated with a known pattern may be deleted or removed from the log 132. This may free up storage space and/or memory of the web server 112. Old entries in the log 132 may also be periodically removed after storage for a threshold period of time.

Although the webpage generator 128, instruction generator 130, log 132, and analysis engine 134 are all shown on one web server 112, these components may be distributed among two or more servers. For example, the webpage generator 128 and instruction generator 130 may exist on one server and the log 132 and/or analysis engine 134 may exist on another server or servers.

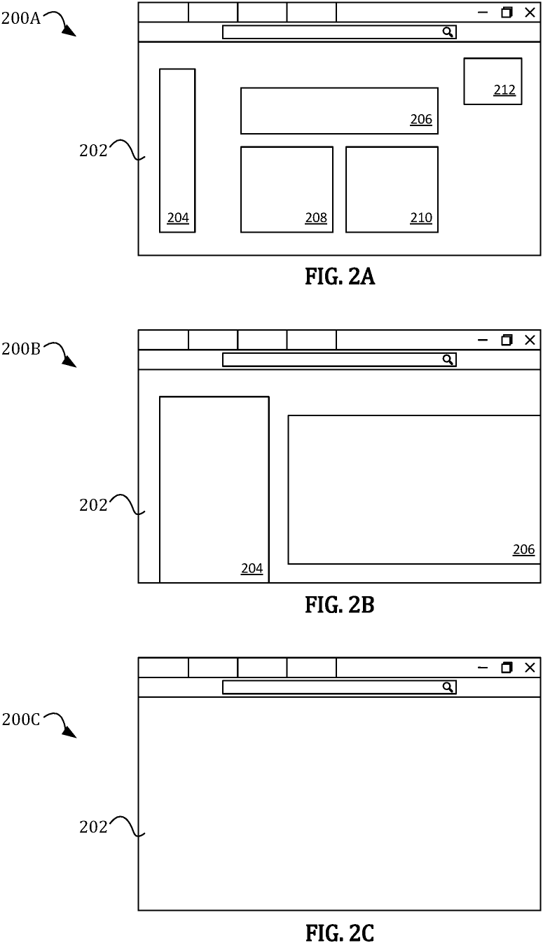

FIGS. 2A-2C depict example webpage renderings 202 on different graphical user interfaces 200A, 200B, 200C. The example webpage renderings 202 are assumed to be of a same webpage. The differences in the webpage renderings 202 are due to differences in the browser information and/or device information of the devices and browsers on which the graphical user interfaces 200A, 200B, 200C are displayed. For example, the graphical user interfaces 200A, 200B, 200C may be loaded with different browser types, different browser versions, different operating systems, etc.

A first graphical user interface 200A with first browser information and first device information may load a proper rendering of the webpage rendering 202 with graphical elements 204, 206, 208, 210, and 212 properly displayed, sized, positioned, etc. As described herein, proper rendering may be determined based on analysis of rendering information about the webpage, which may be based on all or a portion of the webpage rendering 202. Improper renderings of the webpage rendering 202 are shown in a second graphical user interface 200B in FIG. 2B and a third graphical user interface 200C in FIG. 2C. Although the second graphical user interface 200B includes some of the graphical elements 204, 206, the graphical elements 204, 206 shown are improperly sized and positioned and other graphical elements are missing (e.g., graphical elements 208, 210, 212). Thus, the second graphical user interface 200B is an improper, partial rendering of the webpage rendering 202, but is not a blank page. The third graphical user interface 200C is a blank page (e.g., all of the graphical elements 204, 206, 208, 210, 212) are missing. In some situations, a blank page may indicate incompatibility of the web browser loading the webpage rendering 202.

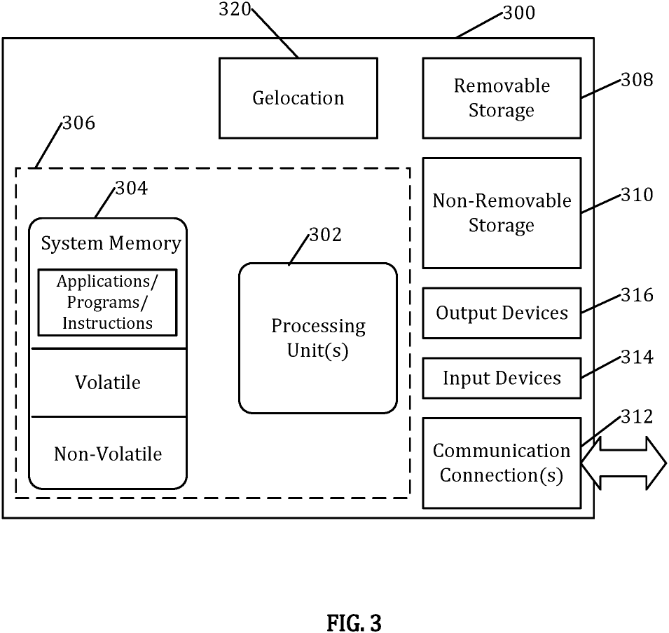

FIG. 3 depicts an example of a suitable operating environment 300 that may be implemented by a client device, web server, system, and/or other computing devices within the systems discussed herein. In its most basic configuration, operating environment 300 typically includes at least one processing unit 302 and memory 304. The processing unit may be a processor, which is hardware. Depending on the exact configuration and type of computing device, memory 304 (storing, instructions to perform the motion detection techniques disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing unit(s) 302, perform the processes and operations described herein, such as evaluating rendering of a webpage or website by one or more browsers on one or more devices, etc. Further, the operating environment 300 may also include storage devices (removable 308, and/or non-removable 310) including, but not limited to, solid-state, magnetic disks, optical disks, or tape. Similarly, the operating environment 300 may also have input device(s) 314 such as keyboard, mouse, pen, voice input, etc. and/or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing unit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

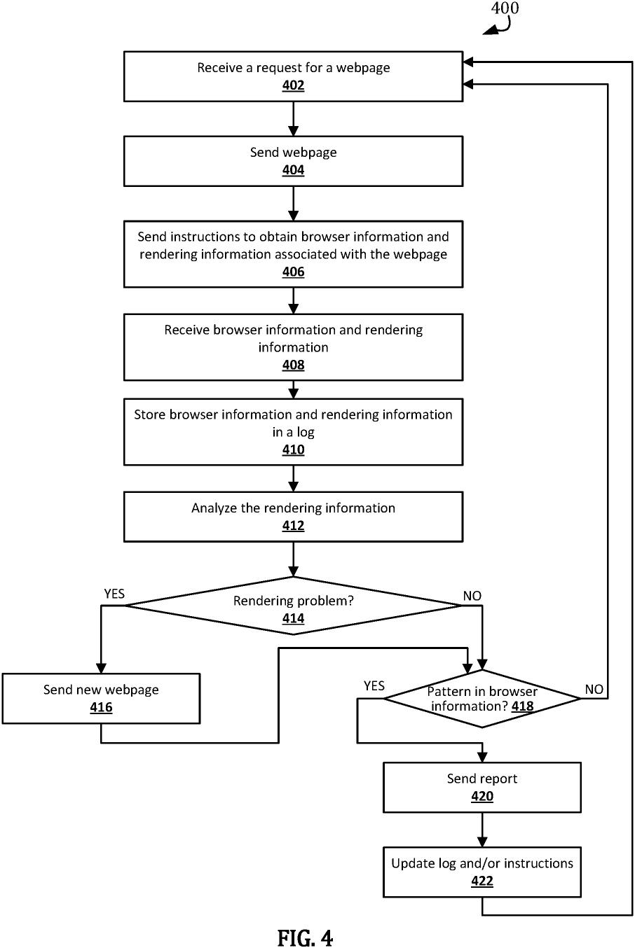

FIG. 4 depicts an example method 400. In examples, method 400 may be performed by from a web server, such as web server 112 and may comprise evaluating rendering of a webpage (or webpages, website, or websites) by one or more browsers. At operation 402 a request for a webpage is received. The request may be sent from a device (e.g., devices 104, 108 in FIG. 1) running a web browser (e.g., web browsers 118, 124). In an example, the request is sent over a network (e.g., network 102). The request may be resolved through a domain name system (DNS) to direct the request to a web server (e.g., web server 112).

At operation 404 the webpage is sent. The webpage may be generated and sent by a webpage generator (e.g., webpage generator 128) of a web server. Sending of a webpage may include sending a script, markup language document, a style sheet, and/or a header. The webpage may be sent from the web server to the requesting web browser over a network.

At operation 406, instructions to obtain browser information and rendering information associated with the webpage are sent. The instructions may be delivered at the same time as the webpage at operation 404. Additionally, the instructions may be included as part of the header sent at operation 404. Alternatively, the instructions may be sent independently of the webpage being sent at operation 404. The instructions are configured to cause the web browser to return browser information and rendering information. In examples, recognition of the instructions by the receiving web browser may require an update or standard to be applied to the web browser.

The browser information may include information associated with the identification of the requesting web browser (e.g., the web browser requesting the webpage at operation 402), such as a type of the browser and/or a version of the browser.

Rendering information is associated with how the webpage is rendered by a receiving web browser. For example, rendering information may include a screenshot (e.g., a screen capture or screen render), a scaled-down version of a screenshot, a text encoding (e.g., Base64 binary-to-text encoding, American Standard Code for Information Interchange (ASCII) code, etc.) of a screenshot, etc. of at least a portion of a webpage loaded on the receiving web browser. The rendering information may be obfuscated, such as through scaling or replacement with lorem ipsum text. The rendering information may be associated with less than the entirety of the webpage, such as a specified quantity of pixels, specified dimensions, specified vertical range of the webpage, the portion of the webpage displayed in a graphical user interface (e.g., the webpage rendering 202 in graphical user interfaces 200A-200C in FIGS. 2A-2C), or other available or specified portion of a loaded webpage. The rendering information may be converted after being received. For example, the web server may receive a screenshot from the web browser and scale down the screenshot, determine a text representation for the screenshot, or otherwise convert the screenshot.

As described, the rendering information is based on a webpage after the webpage has been loaded by the receiving web browser (e.g., instructions to obtain rendering information about a webpage are executed after the webpage is rendered at the web browser). The web browser may be capable of determining when a webpage is loaded, such as upon completion of a progress bar, after completing execution of the received webpage (e.g., completion of reading the script, markup language document, style sheet, and/or header), or after a certain period of time (e.g., a timeout of loading the webpage).

In addition to the rendering information and the browser information, the instructions may also request obtaining device information about the device running the requesting web browser. The device information is information associated with a device, such as an operating system (OS) running on the device, a display size of the device, a device type (e.g., mobile device, desktop device, printer, etc.), etc.

The instructions may be specific for a web browser associated with specific browser information and/or device information. For example, instructions for a first web browser may be executed to obtain rendering information about the webpage. The same instructions for a different web browser may be executed to redirect the web browser to a different webpage (e.g., a low-tech webpage or a webpage with fewer style sheets), without obtaining rendering information. The same instructions for yet another web browser may be executed to provide feedback or visual instructions to a user of the web browser to load the webpage in a different web browser (e.g., feedback indicating that a web browser is incompatible with the webpage and/or providing a list of compatible web browsers for the webpage).

Additionally, the instructions may not be sent with every request (e.g., the request received at operation 402). Timing and/or triggering of the instructions may be based on when rendering information about one or more web browsers is desirable. For example, the instructions may be sent for webpages experiencing slow upload speeds, for webpages experiencing large amounts of traffic, for webpages on which traffic is stuck (e.g., traffic to the webpage does not leave the webpage), after a webpage is created or updated, a same user/device visiting a webpage in different web browsers, etc.

At operation 408, browser information and rendering information (and device information) are received. The browser information and rendering information (if specified in the instructions at operation 406) are received at the requesting web server from the receiving web browser. Additionally, if included in the instructions, device information may also be received. At operation 410, the browser information and rendering information (and, in some cases, the device information) are stored in a log. The log may be hosted on the web server receiving the browser information and rendering information or may be accessible by the web server.

At operation 412, the rendering information is analyzed. The rendering information may be analyzed by an analysis engine (e.g., using AI and/or ML) or by a developer or operator of the webpage associated with the rendering information. Analysis of rendering information may include a comparison of the rendering information with a template having a format comparable with the rendering information, comparison with an image, comparison with other rendering information associated with the same or different browser information, or other comparable file. The analysis of the rendering information may be used to determine if a webpage is rendering properly. Proper rendering may be based on the rendering information being substantially similar to or the same as the comparable file. Improper rendering (or a rendering problem) may be based on the rendering information being substantially different from the comparable file.

At determination 414, it is determined if there is a rendering problem. As described above, a rendering problem may be present if rendering information is substantially different from a comparable file. If a rendering problem is determined, then flow proceeds “YES” to operation 416 where a new webpage is sent. The new webpage may have fewer style sheets than the original webpage sent at operation 404. Alternatively, the new webpage may be a low resolution or low-tech version of the original webpage. Additionally or alternatively to providing a new webpage, feedback may be provided to indicate that the web browser is incompatible and/or provide a list of compatible web browsers.

If a rendering problem is not detected (e.g., the webpage is determined to be properly rendered at determination 414) or after sending a new webpage at operation 416, flow proceeds to determination 418. At determination 418, it is determined if a pattern exists in the browser information. For example, a pattern may exist if proper rendering is detected (e.g., by analyzing rendering information) for browser information and/or device information for two or more, three or more, or four or more, etc. log entries. For example, referring to Table 1, a pattern of proper rendering may be detected for Browser Type 1 running on OS 1 because three log entries of rendering information associated with Browser Type 1 and OS 1 were determined to have proper rendering. In another example, a pattern of improper rendering may be detected for Browser Type 2 running on OS 2 because two log entries of rendering information associated with Browser Type 2 and OS 2 were determined to have improper rendering. Still referring to Table 1, Browser Type 3 may not have a detectable pattern because only one log entry of rendering information is associated with Browser Type 3 (e.g., not enough log entries for the browser information to detect a pattern). Browser Type 1 running on OS 4 may not have a detectable pattern because the log entries have inconsistent evaluations of rendering information (e.g., Image File 5 has improper rendering and Image File 9 has proper rendering).

If no pattern is determined to exist in the browser information, flow proceeds “NO” back to operation 402. For example, if no pattern exists, then there may not be enough information to determine if proper or improper rendering of this specific instance of rendering information is based on the associated browser information and/or device information. Operations 402-418 may repeat as required or desired. For example, a new request for the webpage may be received.

If, alternatively, a pattern is detected in the browser information, flow proceeds “YES” to operation 420. At operation 420, a report is sent. The report sent (e.g., to a developer or operator of the web server) may include an indication that a pattern was detected for browser information and/or device information for the webpage. If the detected pattern indicates that browser information and/or device information consistently, properly renders, then the browser information and/or device information may be certified for the webpage. If, alternatively, the detected pattern indicates that the browser information and/or device information results in improper rendering of the webpage, then then browser information and/or device information may be flagged as suspect.

At operation 422, the log and/or instructions are updated. For example, the log may be updated to remove rendering information associated with a known pattern. The instructions may be updated to not request rendering information from the web browsers having browser information and/or device information associated with a detected pattern. Additionally, if the pattern is associated with suspect rendering, then the instructions may be updated to automatically provide redirecting (e.g., to a low-tech webpage) and/or feedback (e.g., to display a message indicating that the web browser is incompatible) to an incompatible web browser requesting a webpage (e.g., at operation 402). As additional requests are received for the webpage, operations 402-422 may repeat as required or desired.

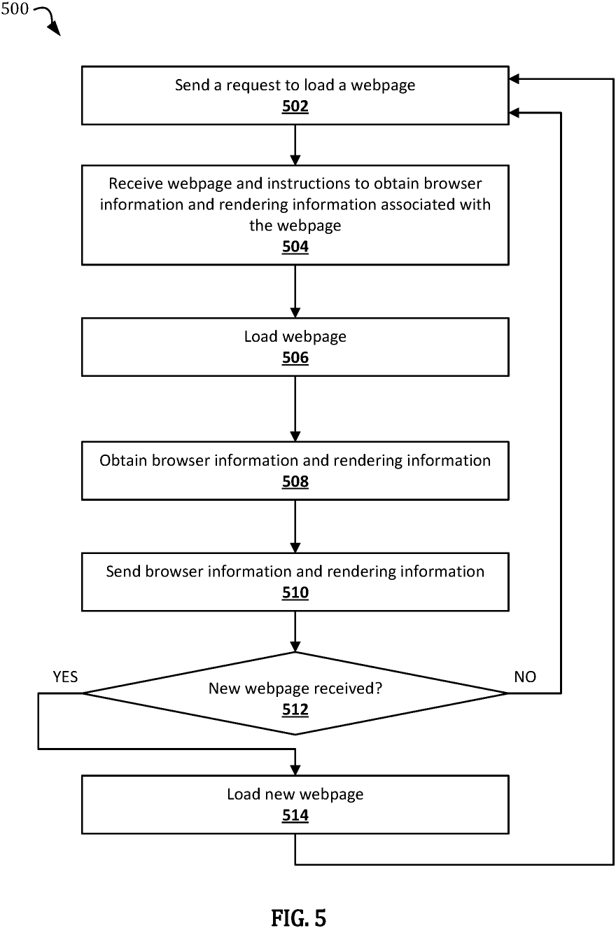

FIG. 5 depicts another example method 500. In examples, method 500 may be performed by a browser, such as browser 118, and may comprise evaluating rendering of a webpage (or webpages, website, or websites). At operation 502 a request to load a webpage is sent. A user (e.g., users 106, 110) of a device (e.g., devices 104, 108) running a web browser (e.g., web browsers 118, 124) may navigate to a webpage in the web browser. The web browser may send the request to fetch the webpage from a web server (e.g., web server 112) hosting the webpage.

At operation 504, a webpage and instructions to obtain browser information and rendering information associated with the webpage are received. As described in operations 404 and 406 of method 400 in FIG. 4, the webpage may include a script, a markup language document, a style sheet, and/or a header. The instructions may be received in the header of the webpage or separately. The instructions may also request obtaining device information about the device on which the web browser is running. The browser information, device information, and rendering information are further described above.

At operation 506, the webpage is loaded. The webpage is loaded based on the webpage provided to the web browser in response to the request sent at operation 502. The web browser may be capable of determining when the webpage is loaded, such as upon completion of a progress bar, after execution of the received webpage, after a timeout, etc.

At operation 508, browser information and rendering information are obtained. The browser information and rendering information (and, in some situations, device information) may be obtained by the web browser in response to executing the instructions received at operation 504. The instructions may be executed after the web browser has completed loading of the webpage at operation 506. Execution of the instructions may be limited by user-controlled privacy settings at the web browser. For example, the rendering information may be anonymized, updated to obscure certain portions of the webpage (or certain pieces of information displayed on the webpage or certain graphical elements), limited to certain portions of the webpage, updated to remove other tabs loaded by the web browser, etc. Privacy settings may also allow a user to prevent capture of rendering information entirely.

At operation 510, the browser information and rendering information (and, in some situations, device information) are sent. As described herein, the browser information, rendering information, and/or device information may be analyzed by a web server to determine if the webpage has rendered properly and if the browser information and/or device information is associated with a pattern of proper or improper rendering of the webpage.

At determination 512, it is determined if a new webpage is received. If a new webpage is not received, then flow proceeds “NO” back to operation 502. If, alternatively, a new webpage is received, then flow proceeds “YES” to operation 514. At operation 514, the new webpage is loaded. If the web browser is not properly rendering the webpage, a new webpage may be received from a web server. The new webpage may have fewer style sheets or may be a low resolution or low-tech version than the original webpage received at operation 504. Additionally or alternatively to providing a new webpage, feedback may be provided for display by the web browser to indicate that the web browser is incompatible with the webpage and/or to provide a list of compatible web browsers.

Operations 502-512 and operations 502-514 may repeat as required or desired. For example, operations may repeat as a user of a device requests or re-requests a webpage from the same or different web browser.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method for evaluating rendering of a webpage, the computer-implemented method comprising:
receiving a request for a webpage;
in response to the request, sending the webpage and instructions to obtain browser information and rendering information associated with the webpage;
receiving the browser information and the rendering information associated with the webpage;
storing at least a portion of the browser information and the rendering information in a log;
analyzing the rendering information; and
certifying the browser information, based at least in part on the rendering information.

2. The computer-implemented method of claim 1, wherein the rendering information is one of:
a screenshot of at least a portion of the webpage;
a compressed image of at least the portion of the webpage; or
a text encoding representative of the screenshot of at least the portion of the webpage.

3. The computer-implemented method of claim 1, wherein the browser information identifies a browser on which the webpage is loaded and a version of the browser.

4. The computer-implemented method of claim 3, wherein the instructions further include obtaining device information about a device on which the browser is running, and wherein the method further includes receiving the device information.

5. The computer-implemented method of claim 1, wherein analyzing the rendering information includes comparing the rendering information to a template.

6. The computer-implemented method of claim 5, wherein the rendering information comprises first rendering information, wherein the log includes second rendering information associated with the browser information, and wherein certifying the browser information is based on the first rendering information, the second rendering information, and the template.

7. The computer-implemented method of claim 6, wherein certifying the browser information includes determining that both the first rendering information and the second rendering match the template.

8. The computer-implemented method of claim 1, the method further including:
updating the log, based on certifying the browser information, wherein updating the log includes removing one or more pieces of rendering information associated with the browser information.

9. The computer-implemented method of claim 1, the method further including:
sending a report indicating that the browser information is certified for the webpage.

10. A computer-implemented method for evaluating rendering of a webpage, the computer-implemented method comprising:
receiving a request for a webpage;
in response to the request, sending the webpage and instructions to obtain browser information and rendering information associated with the webpage;
receiving the browser information and the rendering information associated with the webpage;
storing at least a portion of the browser information and the rendering information in a log;
analyzing the rendering information; and
determining that the browser information is suspect, based at least in part on the rendering information.

11. The computer-implemented method of claim 10, wherein the rendering information is one of:
a screenshot of at least a portion of the webpage;
a compressed image of at least the portion of the webpage; or
a text encoding representative of the screenshot of at least the portion of the webpage.

12. The computer-implemented method of claim 10, wherein the rendering information is a first rendering information, wherein the log includes a second rendering information associated with the browser information, and wherein determining that the browser information is suspect is based on the first rendering information and the second rendering information each being different from a template.

13. The computer-implemented method of claim 10, wherein the webpage is a first webpage, and wherein the method further includes:
based on determining that the browser information is suspect, sending a second webpage.

14. The computer-implemented method of claim 13, wherein the second webpage is low-tech version of the first webpage.

15. The computer-implemented method of claim 10, the method further including:
sending a report indicating that the browser information is suspect for the webpage.

16. The computer-implemented method of claim 10, the method further including:
updating the log, based on determining that the browser information is suspect for the webpage, wherein updating the log includes removing one or more pieces of rendering information associated with the browser information.

17. A system for evaluating rendering of a webpage, the system comprising:
at least one processor; and
memory storing instructions that when executed by the at least one processor cause the system to perform a set of operations comprising:
receiving, from a browser, a request for a webpage;
in response to the request, sending, to the browser, the webpage and instructions to obtain browser information and rendering information associated with the webpage to be loaded at the browser, wherein the browser information identifies a type of the browser;
receiving, from the browser, the browser information and the rendering information associated with the webpage;
storing at least a portion of the browser information and the rendering information in a log;
comparing the rendering information with a template; and
based at least on comparing the rendering information with the template, certifying the browser information for the webpage.

18. The system of claim 17, wherein the rendering information is one of:
a screenshot, taken by the browser, of at least a portion of the webpage;
a converted image of the screenshot taken by the browser; or
a text encoding representative of the screenshot taken by the browser.

19. The system of claim 17, wherein certifying the browser information for the webpage further includes determining that the rendering information matches the template.

20. The system of claim 17, the set of operations further including:
based on certifying the browser information, removing one or more pieces of rendering information associated with the browser information from the log.
